(19) United States
(12) Patent Application Publication
(10) Pub. No.: US 2026/0100923 A1
(43) Pub. Date: Apr. 9, 2026

(54) METHOD FOR INTEGRATING A GENERATIVE AI TOOL WITH INTELLIGENT AGENT DASHBOARD AND SYSTEM THEREOF

(71) Applicant: GUPSHUP TECHNOLOGY INDIA PRIVATE LIMITED, Maharashtra (IN)

(72) Inventor: Nirmesh MEHTA, Maharashtra (IN)

(21) Appl. No.: 19/351,394

(22) Filed: Oct. 7, 2025

(30) Foreign Application Priority Data
Oct. 7, 2024 (IN) 202421075726

(51) Int. Cl. H04L 51/02; H04L 51/216

(52) U.S. Cl. CPC H04L 51/02; H04L 51/216

(57) ABSTRACT

The present invention discloses a method and a system (100) for integrating a generative AI tool with intelligent agent dashboard. The System (100) comprises a user device (102), a communication channel (104), a backend of the agent dashboard system (106), a user interface (UI) of the agent dashboard system (108), a generative artificial intelligence (GenAI) (110), a backend of the proposed system (112) and a widget (114). The agent composes a reply to a user by using the integration of the proposed system (100), wherein the externally connected widget (114) is embedded in the compose screen of the agent dashboard with GenAI (110) integration. The custom compose screen sends the reply to the backend of the proposed system (112) with additional metadata mentioning the GenAI (110) selection/edits.

### CROSS REFERENCE TO RELATED APPLICATION AND PRIORITY

The present invention claims priority from Indian Patent Application number 202421075726 filed on date 07th October 2024.

### FIELD OF THE INVENTION

The present invention relates to the field of agent dashboards and more particularly to a method and system for integrating a Generative AI (GenAI) tool with an agent dashboard to provide suggested replies to user messages. The invention also relates to a user interface (UI) widget for displaying the suggested replies and interacting with the GenAI tool.

### BACKGROUND OF THE INVENTION

Generative AI tools are a category of artificial intelligence tools designed to produce new and original contents such as text, images, audio, video, or code. The generative AI tools can create the original content by learning patterns and structures from massive and various datasets. The generative AI tools are trained on vast amounts of existing information, this allows them to generate novel and original outputs. The output content created by the generative AI tools resembles as human-created content in response to a user prompt.

Currently, marketers are widely using generative AI tools for messaging. A big area of cost optimization is in support of use cases. In particular, where human agents provide support to end customers over messaging. The generative AI can be used to transparently receive a lot of load. However, implementing generative AI in legacy support tools requires a lot of time-consuming changes and extensive modifications to the current infrastructure, resulting in high implementation costs.

Hence to overcome the aforesaid drawbacks a system and method for integration of an embeddable compose screen in the agent dashboard is required.

### OBJECTS OF THE INVENTION

Main object of the present disclosure is to provide a system to integrate a compose widget in any agent dashboard as an externally linkable widget.

Another object of the present disclosure is to integrate the generative AI dashboard with GenAI integration via the proposed system.

Yet another object of the present disclosure is to provide human agents receive suggestions from GenAI regarding how to respond to end-user queries.

Yet another object of the present disclosure is to reduce human agent effort and the cost of integration.

Yet another object of the present disclosure is to eliminate the need for a complete system overhaul and reduce development time.

Yet another object of the present disclosure is to provide contextually relevant AI-generated suggestions.

Yet another object of the present disclosure is to provide feedback loop mechanism for training the GenAI tool

Yet another object of the present disclosure is to reduce latency and improve efficiency.

Yet another object of the present disclosure is to ensure uninterrupted agent workflows using the embedded widget.

Yet another object of the present disclosure is to enhance agent productivity and reduces decision fatigue for support agents.

Yet another object of the present disclosure is to support diverse user devices and compatible with various messaging channels.

Yet another object of the present disclosure is to facilitate language translation.

Yet another object of the present disclosure is to facilitate voice integration.

Yet another object of the present disclosure is to provide a system capable to update, scale, or replace independently the modules.

### SUMMARY OF THE INVENTION

Before the present method for integrating a generative AI tool with intelligent agent dashboard and a system thereof is described, it is to be understood that this application is not limited to a particular integration of an embeddable compose screen in the agent dashboard as there may be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to the method for integrating a generative AI tool with intelligent agent dashboard and the system thereof. This summary is not intended to identify essential features of the claimed subject matter nor is it intended for use in determining or limiting the scope of the claimed subject matter.

The present invention discloses a system for integrating a generative AI tool with an agent dashboard comprises a memory configured to store information, including message metadata, target user lists, and message templates, and a processor operably coupled to the memory. The processor is configured to receive a user message from a user device via a communication channel and a backend module, transmit the user message to a user interface (UI) of an agent dashboard, which includes an embeddable widget having a compose screen, and transmit the user message from the widget to an SBackend module for communication with a generative AI tool. The processor further obtains, from the generative AI tool, one or more suggested replies based on the user message and historical interaction data stored in the memory, displays the suggested replies inline within the widget's compose screen for an agent, enables altering of the suggested replies and drafting of a final reply within the widget, monitors agent interactions with the suggested replies to capture interaction metadata indicating whether the replies were accepted, modified, or ignored, transmits the final reply and interaction metadata from the SBackend module to the backend module for communication with the generative AI tool, delivers the final reply from the backend module to the user device via the communication channel, and updates the generative AI tool using the interaction metadata transmitted via the SBackend module to enable iterative retraining and model refinement.

In an embodiment, the present invention provides that capturing the interaction metadata within the widget comprises detecting a selection event when the human agent chooses one of the suggested replies without modification, detecting an editing event when the human agent modifies the suggested reply before transmission as the final reply, and detecting an ignore event when the human agent drafts the final reply independently of the suggested replies. The widget generates metadata corresponding to the detected events and forwards the metadata to the SBackend module.

In yet another embodiment, the present invention provides the UI displays the user message to the agent with an embeddable compose screen, and wherein each agent from a plurality of agents accesses the UI for interaction with a user from a plurality of users.

In still another embodiment, the present invention provides that the generative AI tool is configured to generate one or more suggested replies to the received user message and comprises a large language model (LLM) trained on historical data and the user messages. The historical data includes domain-specific knowledge, customer support datasets, and historical interaction data.

In an embodiment, the present invention provides that the widget is operably connected to the processor through the SBackend module, such that all communication between the widget and the generative AI tool is routed via the SBackend module. The widget generates the interaction metadata by logging click events, keystroke activity, or input differentials corresponding to the agent's interaction.

In still another embodiment, the present invention provides that the metadata comprises user identifiers, user messages, agent replies, generative AI-generated replies, agent-edited replies, advertisement identifiers, referral codes, attributes required to uniquely identify and track messages, generative AI-generated suggestions, the selected or edited version, agent interactions, timestamps, campaign identifiers, use-case category, and tags indicating the agent's interaction behavior.

In an embodiment, the present invention provides that the embeddable compose screen is implemented as a reusable web component comprising a text input box for composing replies, a section for rendering generative AI-suggested replies, and scripting logic for sending and receiving messages to and from the generative AI backend.

In still another embodiment, the present invention provides that the embeddable compose screen is integrated into the agent dashboard by replacing a pre-existing compose text box with a custom web component.

In yet another embodiment, the present invention provides that the UI of the agent dashboard further comprises a multilingual preview display, a scorecard for AI reply quality, a tone or style recommender, conversation history, user information, interaction metadata, report, and contextual metadata display.

In an embodiment, the present invention provides a method for integrating a generative AI tool with an intelligent agent dashboard uses a system comprising a memory and a processor operably coupled to the memory, wherein the memory is configured to store message metadata, target user lists, and message templates. The method includes receiving, by the processor, a user message from a user device via a communication channel and a backend module; transmitting the user message to a user interface (UI) of the agent dashboard, which includes an embeddable widget having a compose screen; transmitting the user message from the widget to an SBackend module for communication with the generative AI tool; obtaining, from the generative AI tool, one or more suggested replies based on the user message and historical interaction data stored in the memory; displaying the suggested replies inline within the widget's compose screen for an agent; enabling the agent to alter the suggested replies and draft a final reply within the widget; monitoring, within the widget, interactions of the agent with the suggested replies to capture interaction metadata indicating whether the replies were accepted, modified, or ignored; transmitting the final reply and the interaction metadata from the SBackend module to the backend module for communication with the generative AI tool; delivering the final reply from the backend module to the user device via the communication channel; and updating the generative AI tool using the interaction metadata transmitted via the SBackend module to enable iterative retraining and model refinement.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure. The detailed description is described with reference to the following accompanying figures.

FIG. 1(a): illustrates a network implementation of a system for integrating a Generative AI (GenAI) tool with an agent dashboard, in accordance with an embodiment of the present subject matter.

FIG. 1(b): illustrates the architecture of the system for integrating a Generative AI (GenAI) tool with the agent dashboard, in accordance with an embodiment of the present subject matter.

FIG. 2: illustrates an agent dashboard without GenAI integration in a preferred embodiment of the present invention.

FIG. 3: illustrates the agent dashboard with GenAI integration in a preferred embodiment of the present invention.

FIG. 4: illustrates the agent dashboard with GenAI integration via the proposed system in a preferred embodiment of the present invention.

FIG. 5: illustrates the integration of a widget in the compose screen of the agent dashboard in a preferred embodiment of the present invention.

FIG. 6: illustrates a flow chart performing a method for integrating a Generative AI (GenAI) tool with an agent dashboard, in accordance with an embodiment of the present subject matter.

The figure depicts various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein. Following is a list of elements and reference numerals used to explain various embodiments of the present subject matter.

| Reference Numeral | Element Description |
|---|---|
| 100 | System |
| 102 | User device |
| 103 | Network |
| 104 | Communication Channel |
| 105 | Memory |
| 106 | Backend module |
| 107 | Processor |
| 108 | User interface (UI) of the agent dashboard system |
| 110 | Generative artificial intelligence (GenAI) |
| 112 | SBackend module |
| 114 | Widget |
| 116 | Agent |

Existing implementations of Artificial Intelligence (AI) tools with customer support systems requires extensive and substantial modifications to the current infrastructure, resulting in high implementation costs and long deployment times. Accordingly, there exists a need for a system and method that facilitates the seamless integration of generative AI capabilities into legacy support environments without necessitating extensive architectural changes. Further, there is a need for an embeddable compose screen within the agent dashboard, which allows generative AI to be utilized with minimal disruption to existing workflows and systems.

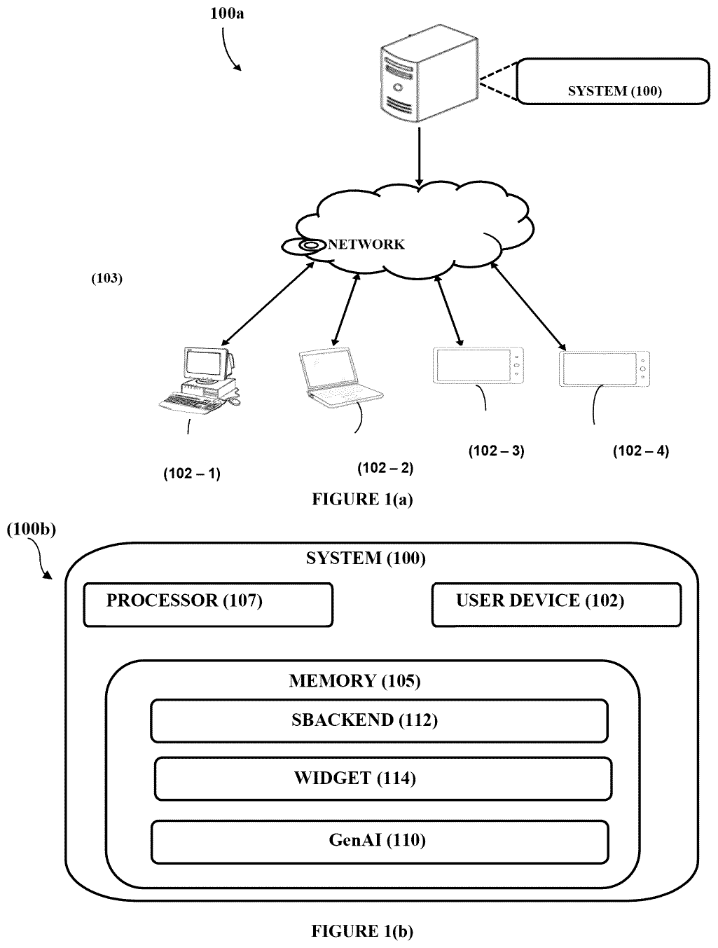

Referring now to FIG. 1(a), a network implementation (100a) of a system (100) is illustrated. The system (100) is being implemented on a server, it can be understood that it may also operate on various computing systems, such as laptops, desktops, notebooks, workstations, mainframes, or within cloud-based environments. Multiple users can access the system (100) through various user devices (102-1) (102-2) (102-3) (102-4), collectively referred to as users or stakeholders, which may include IoT devices, IoT gateways, portable computers, personal digital assistants, handheld devices, and workstations, all communicatively coupled to the system (100) through a network (103). This network (103) may be wireless, wired, or a combination of both, and can take the form of intranets, local area networks (LAN), wide area networks (WAN), or the internet, utilizing various protocols such as HTTP, HTTPS, and TCP/IP. Furthermore, the network (103) may comprise a range of devices, including routers, bridges, servers, and storage devices.

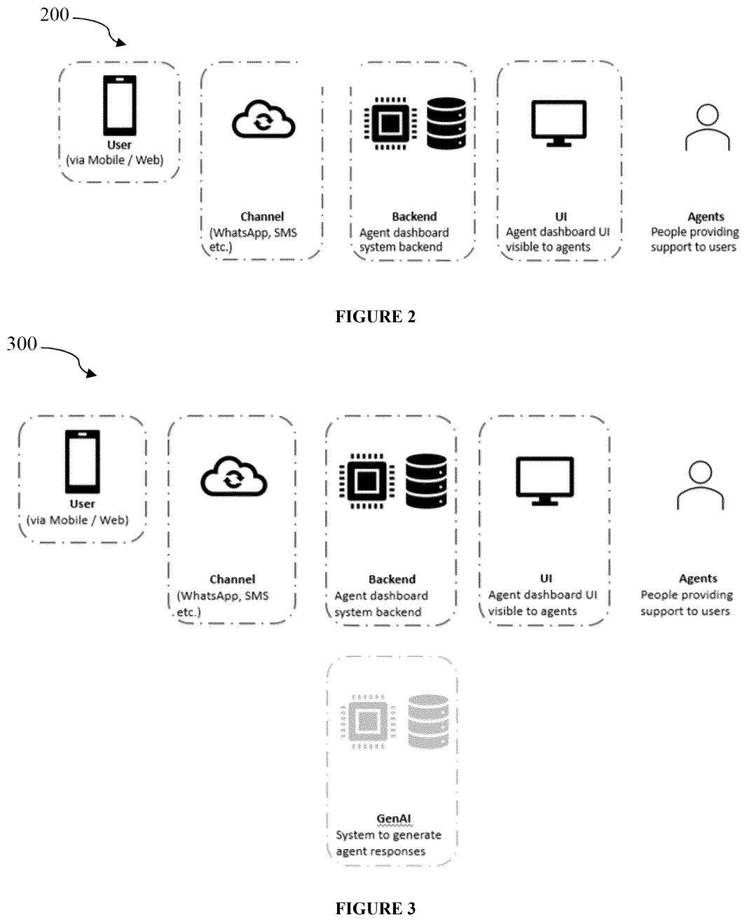

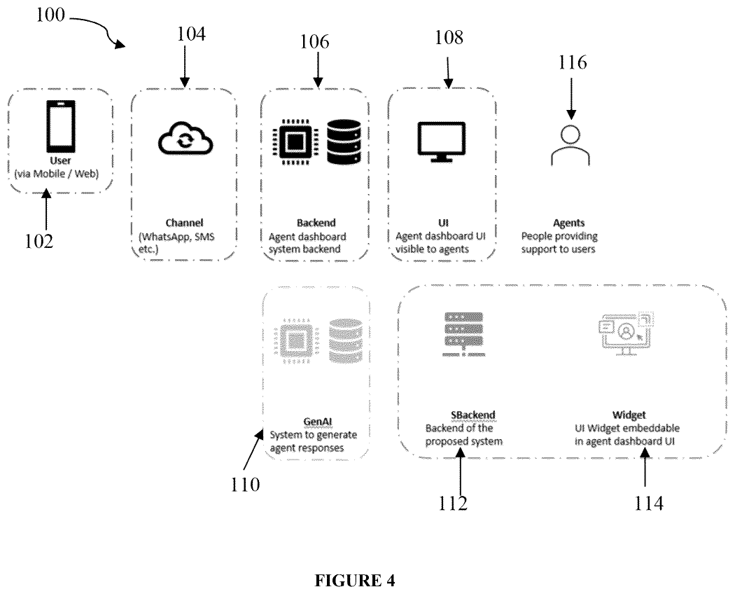

Referring now to FIG. 1(b), illustrates the architecture of a system (100) for integrating a GenAI tool (110) with an agent dashboard, in accordance with an embodiment of the present subject matter. As shown, the system (100) includes a user device (102) operably connected to a communication channel (104) (as shown in FIG. 2, FIG. 3 and FIG. 4 through which messages are transmitted and received. The communication channel (104) may comprise any suitable communication medium such as SMS, email, webchat, or over-the-top (OTT) messaging applications. A backend module (106) (as shown in FIG. 2, FIG. 3 and FIG. 4) is operably coupled to the communication channel (104). The backend module (106) manages the delivery of outbound messages to users and the reception of inbound replies from the user device (102). In one embodiment, the inbound replies from the user device (102) may be referred as a user message.

The system further comprises a memory (105) and a processor (107), where the memory (105) stores information/metadata related to messages including, but not limited to, message metadata, target user lists, and message templates. The processor (107) is configured to execute instructions stored in the memory (105) to control system operation. An agent dashboard module (108) (as shown in FIG. 4) provides a user interface (UI), displays the user message to an agent (116) and includes a compose screen (114) that allows the agent (116) to compose a reply. The compose screen (114), implemented by the processor (107), enables a Sbackend module (112) to send the user message to a GenAI tool (110) and receive messages from the GenAI tool (110). In one embodiment, the compose screen (114) may be referred as a widget (114).

The GenAI tool (110), implemented by the processor (107), generates suggested replies based on the user message, and transmits the suggestions to the widget (114) via the SBackend module (112). The agent (116) may select one of the suggested replies or edit a suggested reply within the widget (114), and subsequently send a final reply to the user device (102). The widget (114), implemented by the processor (107), transmits the final reply to the SBackend module (112) along with additional metadata. The additional metadata indicates whether a GenAI-generated reply was selected or edited by the agent.

The Sbackend module (112), implemented by the processor (107), forwards this metadata to the GenAI module (110) for training and continuous improvement. The metadata may include, but is not limited to: user identifiers, user messages, agent replies, GenAI-generated replies, agent-edited replies, advertisement identifiers, referral codes, and other attributes required to uniquely identify and track messages.

Referring to FIG. 2, an agent dashboard without GenAI integration is illustrated. In accordance with an embodiment of the present invention, the agent dashboard system (200) comprises a user device (102), a communication channel (104), a backend module (106), and an user interface (UI) of the agent dashboard system (108). Particularly FIG. 1 indicates that a user initiates communication by sending a message through a messaging channel (104). The message is received by the backend system (106), which then processes and forwards it to the user interface (UI) (108). The message is then displayed to an agent (116) via the UI (108), along with a compose screen for drafting a response. The agent (116) crafts a reply and sends it back to the UI, which in turn forwards it to the backend module (106). Finally, the backend module (106) transmits the reply to the communication channel (104), which delivers it to the user on the user device (102).

In one embodiment, the communication channel (104) is an email interface. The user sends a customer service inquiry through email (e.g., help@example.com), which is routed to the backend module (106) referred as a backend email server. The backend parses the email content and forwards it to the agent dashboard UI (108), where the agent (116) views the message and replies using a standard text input box. The backend module (106) then sends the agent response back to the user email address.

In another embodiment, the communication channel (104) comprises an OTT messaging platform such as a WhatsApp, a telegram, a signal and the like. A user sends a message using the WhatsApp app on their phone (102), which is received by the WhatsApp Business API connected to the backend module (106). The backend module (106) forwards the message to the UI (108), where an agent (116) reads the message and responds using a compose screen. The reply is sent back through the backend module (106) and ultimately delivered to the user via the WhatsApp app.

The system (200) is an agent dashboard without GenAI integration and all replies are composed manually by the agent, with no AI-generated suggestions or automation support, this leads to various drawbacks and challenges. The system (200) lacks dynamic adaptation to the tone, sentiment, or context of the message. The system (200) is time consuming method, reduce agent productivity, limit or delay in real-time support. The system (200) lacks training data to improve response. Further, during high-volume messaging, the system (200) requires proportional scaling of human agents, which increases operational cost.

Further below table illustrates the method steps or sequence of action performed by the system without Gen AI:

| Sr | | | |
|---|---|---|---|
| No | From | To | Details |
| 1 | User | Channel | User sends a message over the messaging channel. |
| 2 | Channel | Backend | The messaging channel forwards the message to the |
| | | | backend system of the agent dashboard. |
| 3 | Backend | UI | The backend sends the user message to the UI. |
| 4 | UI | Agent | The UI displays the user message and shows a |
| | | | compose screen that allows the agent to compose a |
| | | | reply. |
| 5 | Agent | UI | The agent composes a reply. |
| 6 | UI | Backend | The UI sends the reply to the backend. |
| 7 | Backend | Channel | The backend sends the reply to the channel. |
| 8 | Channel | User | The channel sends and renders the message to the user. |

Referring to FIG. 3, an agent dashboard with a direct GenAI integration is illustrated. In accordance with an embodiment of the present invention the agent dashboard system (300) comprises the user device (102), the communication channel (104), the backend module (106), an user interface (UI) of the agent dashboard system (108), and a generative artificial intelligence (GenAI) (110). During operations, a user initiates communication by sending a message through the communication channel (104) which forwards the message to the backend module (106) of the agent dashboard. The backend module (106) then forwards or transmits this user message to the GenAI tool (110), which processes the user message and generates one or more suggested replies. In one embodiment, the backend module (106) then forwards or transmits this user message to the GenAI tool (110) for training the tool (110) to generate response. The generated replies from the GenAI tool (110) are returned to the backend module (106), which then forwards both the original user message and the GenAI-generated suggestions to the user interface (UI) (108). The UI (108) displays this information to the agent (116), who may review the suggested replies, select one, or modify it as needed. The agent (116) then submits a final reply via the UI (108). The UI (108) transmits this final reply to the backend module (106), along with metadata. The metadata may include, but not limited to, detailing the GenAI-generated suggestions, the selected or edited version, any agent interactions, user IDs, message content, timestamps, campaign identifiers, use-case category, and tags indicating the agent's interaction behaviour. This metadata is sent to the GenAI tool (110) for training, refinement, and continuous improvement.

Finally, the backend module (106) forwards the agents reply to the communication channel (104), which delivers the message to the user on the user device (102).

Further below table illustrates the method steps or sequence of action performed by the system with Gen AI:

| Sr | From | To | Details |
|---|---|---|---|
| 1 | User | Channel | User sends a message over the messaging channel. |
| 2 | Channel | Backend | The messaging channel forwards the message to the |
| | | | backend system of the agent dashboard. |
| 3 | Backend | GenAI | The backend sends the message to the GenAI tool. |
| 4 | GenAI | Backend | The GenAI tool generates suggested reply(ies) and |
| | | | returns the same to the backend. |
| 5 | Backend | UI | The backend sends the user message and the suggested |
| | | | replies to the UI. |
| 6 | UI | Agent | The UI displays the user message and suggested replies |
| | | | to the agent. |
| 7 | Agent | UI | The agent edits or selects within the replies and sends a |
| | | | final reply to the user. |
| 8 | UI | Backend | The UI sends the reply to the backend together with |
| | | | additional metadata mentioning the GenAI selection / |
| | | | edits. |
| 9 | Backend | GenAI | The backend forwards the metadata to GenAI for training |
| | | | and improvement purposes. |
| 10 | Backend | Channel | The backend sends the reply to the channel. |
| 11 | Channel | User | The channel sends and renders the message to the user. |

Referring to FIG. 4, depicts the integration of the proposed system (100) i.e., embeddable compose screen in the agent dashboard with GenAI (110) integration. In accordance with this embodiment of the present invention, the system (100) comprises the user device (102), the communication channel (104), the backend module (106), the user interface (UI) of the agent dashboard system (108), the generative artificial intelligence (GenAI) (110), a SBackend module (112), and a compose screen (114). During operation, a user initiates communication by sending a message through the communication channel (104), which forwards the message to the agent dashboard's backend module (106). The backend module (106) transmits the user message to the UI (108), which then displays the message to the agent (116) along with the embeddable custom compose screen (114). This screen, or widget, sends the message to the proposed system's backend module referred as Sbackend module (112), which in turn is integrated with the GenAI tool (110) for potential reply suggestions. The GenAI tool (110) generates one or more contextually relevant reply suggestions, which are returned to the Sbackend module (112), and subsequently presented to the agent within the compose screen or widget (114). The GenAI tool (110) generates the one or more contextually relevant reply suggestions, based on the user message and the historical data. The historical data comprises domain-specific knowledge, customer support datasets, and historical interaction data. The agent (116) can then select, edit or modify any of the suggested replies before sending a final reply back to the user. This reply, along with metadata about the agent's interaction with the suggestions, is sent to the proposed system's backend (Sbackend module (112)) for potential AI model improvement by retraining the AI model. Finally, the reply is forwarded from the compose screen (114) to the UI (108), then to the backend module (106), and ultimately delivered to the user through the communication channel (104).

In one embodiment, the user device (102) may be a mobile device, a web, a computer device, a laptop, a tablet, and the like. The user device (102) may be associated with a user. In one example, each user from a plurality of users may be using the user device (102).

Further below table illustrates the method steps or sequence of action performed by the Agent Dashboard with GenAI integration via proposed system:

| Sr | From | To | Details |
|---|---|---|---|
| 1 | User 102 | Channel | User sends a message over the messaging channel. |
| | | 104 | |
| 2 | Channel | Backend | The messaging channel forwards the message to the |
| | 104 | 106 | backend system of the agent dashboard. |
| 3 | Backend | UI 108 | The backend sends the user message to the UI. |
| | 106 | | |
| 4 | UI 108 | Agent 116 | The UI displays the user message and shows custom |
| | | | compose screen of the proposed system that allows the |
| | | | agent to compose a reply. |
| 5 | Widget | SBackend | The custom compose screen sends the message to the |
| | 114 | 112 | backend of the proposed system |
| 6 | SBackend | GenAI 110 | The backend sends the message to the GenAI tool. |
| | 112 | | |
| 7 | GenAI | SBackend | The GenAI tool generates suggested reply(ies) and |
| | 110 | 112 | returns the same to the backend. |
| 8 | SBackend | Widget | The backend sends the user message and the suggested |
| | 112 | b114 | replies to the UI. |
| 9 | Widget | Agent116 | The custom compose screen displays suggested replies |
| | 114 | | to the agent. |
| 10 | Agent 116 | Widget 114 | The agent edits or selects within the replies and sends |
| | | | a final reply to the user. |
| 11 | Widget | SBackend | The custom compose screen sends the reply to the |
| | 114 | 112 | proposed system backend together with additional |
| | | | metadata mentioning the GenAI selection / edits. |
| 12 | SBackend | GenAI 110 | The proposed system backend forwards the metadata |
| | 112 | | to GenAI for training and improvement purposes. |
| 13 | Widget | UI 108 | The widget sends the reply to the UI. |
| | 114 | | |
| 14 | UI 108 | Backend | The UI sends the reply to the backend. |
| | | 106 | |
| 15 | Backend | Channel | The backend sends the reply to the channel. |
| | 106 | 104 | |
| 16 | Channel | User102 | The channel sends and renders the message to the user. |
| | 104 | | |

Further, the communication channel (104) may be a platform used for communication by the user and an agent. The communication channel (104) may be one of a WhatsApp platform, an email, a messaging platform, SMS, a webchat, and the like. In one example, the communication channel (104) may correspond to either a native or web-based application downloaded or installed on the user device (102) by the user.

Furthermore, the agent dashboard may be connecting a plurality of agents to the plurality of users. The agent dashboard may comprise a user interface (108) that is visible to each of the plurality of agents (116). Each agent (116) from the plurality of agents may access the agent dashboard using an agent device (not shown). The agent device may be one of a mobile device, a computer system, a laptop, a tablet, and the like. In one embodiment, each agent from the plurality of agents (116) may provide assistance to the plurality of users. The assistance may be associated with the replies/answers/services to the user queries. In one embodiment, the agent dashboard also displays conversation history, user information, interaction metadata, report, and a contextual view of the conversation for aiding the agent in making more personalized and accurate responses.

In an embodiment, the UI (108) of the agent dashboard may include, but not limited to, additional widgets such as a scorecard for each AI-suggested reply, a tone or style recommendations, and a multi-lingual or multi language preview for various users. The tone or style recommendations may include formal, empathetic, concise, polished, elaborate, and the like.

Further, the Generative AI (GenAI) tool (110) is a platform that delivers automated replies, AI-generated answers in response to customer/user requests, and capable of generating one or more contextually relevant reply suggestions. In an embodiment, the generative AI (GenAI) tool (110) is an external or embedded platform configured to generate automated responses to the user messages. In one embodiment, the GenAI tool (110) comprises large language models (LLMs) trained on customer support datasets, domain-specific knowledges, and historical interaction data. In an embodiment, the GenAI tool (110) is implemented as a third-party API, accessible over a secure network connection and hosted in a cloud environment. In another embodiment, the GenAI tool (110) is hosted on-premises, suitable for enterprises with strict data governance and privacy requirements. In another embodiment, the GenAI tool (110) is deployed in a hybrid configuration, combining both cloud-based and on-premises components.

In one embodiment, the widget (114) is installed in the compose screen of the agent dashboard. In one example, the Widget (114) may be a Gadget, tool, appliance, gizmo, mechanism, contraption, jigger, plugins, or accessory integrated into existing customer support software platforms, requiring minimal code changes and enabling fast deployment. Further, the widget (114) is implemented as scripting logic for handling the communication flow between the widget and a GenAI backend.

In an embodiment, the system (100) allows the individual components such as the UI (108), the SBackend module (112), the GenAI tool (110), the widget (114) to be updated, scaled, or replaced independently. In one embodiment, the system (100) may facilitates features such as a language translation, a sentiment analysis, and a voice integration.

The integration of an embeddable compose screen (widget) with Generative AI (GenAI) into the agent dashboard offers several distinct advantages over conventional customer support systems. These advantages include requiring minimal modifications to legacy systems, eliminating the need for a complete system overhaul, reducing development time, lowering integration effort, and minimizing operational risk. The system (100) further enhances agent productivity and reduces decision fatigue for support agents. It is compatible with various messaging channels and supports diverse user devices.

The system (100) enables inline editing, selection, and submission of replies within the compose screen without requiring context switching, thereby ensuring uninterrupted agent workflows. Additionally, it reduces the risk of human error by providing contextually relevant AI-generated suggestions. The system includes a feedback loop mechanism that sends agent interactions and metadata back to the GenAI tool (110) for continuous fine-tuning and performance improvement, enabling the AI to learn from real-world interactions over time.

Furthermore, the system (100) is designed with an efficient backend architecture that ensures minimal latency, making it suitable for time-sensitive applications such as live chat, crisis response, and high-volume customer support environments.

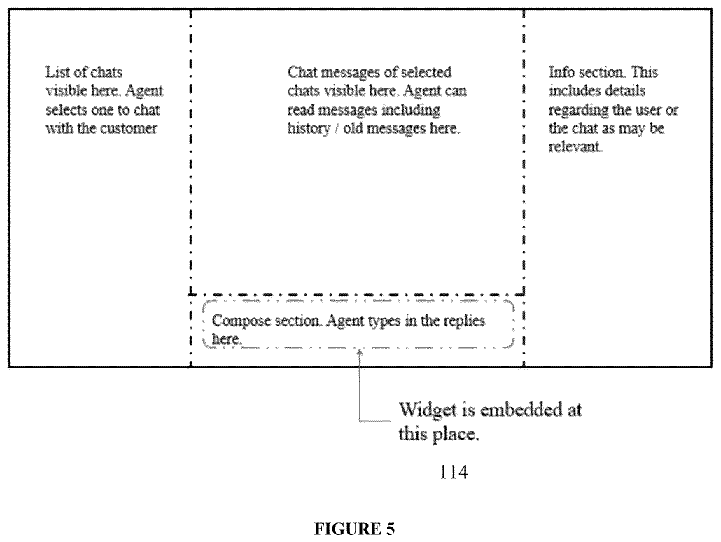

Referring to FIG. 5, depicts the schematic UI of a typical Agent Dashboard system together with position where the widget would be embedded.

In one embodiment, one way to implement and integrate the Widget (114) may be via web Components. Web components offer a promising approach to integrate the Gen-AI functionality into the agent dashboard. These reusable building blocks, combining HTML, CSS, and Javascript, can be seamlessly embedded within the existing interface. Implementing the widget would involve creating a custom component named “agent-widget.” This component would require the development of CSS and HTML to display the compose text box and render the Gen-AI suggestions. Additionally, Javascript code would be needed to fetch incoming messages, send them to the GenAI backend, receive the suggestions, and display them within the widget. Finally, all these elements (CSS, HTML, and Javascript) would be bundled into a single Javascript file for easy integration.

Implementing the Widget (114) may involve creating a custom component (agent-Widget (114)) as per the one embodiment disclosed above. Further, implementation may require generating the CSS and HTML to show the compose text box, together with additional HTML elements to render the suggestions as provided by the GenAI backend. The System (100) may also involve Java script code that can fetch the incoming messages from the chat messages section, further sending it to the GenAI backend, get back the response and render the suggestion in the Widget (114) section.

Furthermore, the Widget (114) may include all the web component assets such as (CSS, HTML, Java script) packaged as a Java script file.

In one embodiment, the integration details of the Widget (114) in the proposed system (100) of the agent dashboard is given below.

The Javascript file can be integrated and made available in the Agent Dashboard portal by including it via a script tag in the ‘head’ section of the web page (e.g.: <script type=‘module’ src=‘[distribution locationURL]/agentwidget.js’>

After the file is made and available in the portal of the agent dashboard, the HTML of the Agent Dashboard portal needs to be modified to use the custom Widget (114) component. Before integration, the compose text box is in a <div></div> section, and the compose text box needs to be replaced with a <agent-widget></agent-widget> section.

The integrating developer may (optionally) use CSS to make changes to the Widget (114) styling to make it consistent with the styling of the rest of the page.

The integrating developer may need to integrate Javascript to fetch the composed reply from the Widget (114) in place of taking it from the compose text box.

In another embodiment, a process for interacting the Widget (114) with the operating environment is given below.

Upon an agent's login, the agent dashboard, including the integrated widget, loads. When a new message arrives, the widget intercepts it and sends a request to the GenAI backend for potential responses. These suggestions are then displayed within the widget, offering the agent options to select, modify, or compose a new reply. Once finalized, the agent's response, along with usage metadata, is sent back to the backend for AI model refinement.

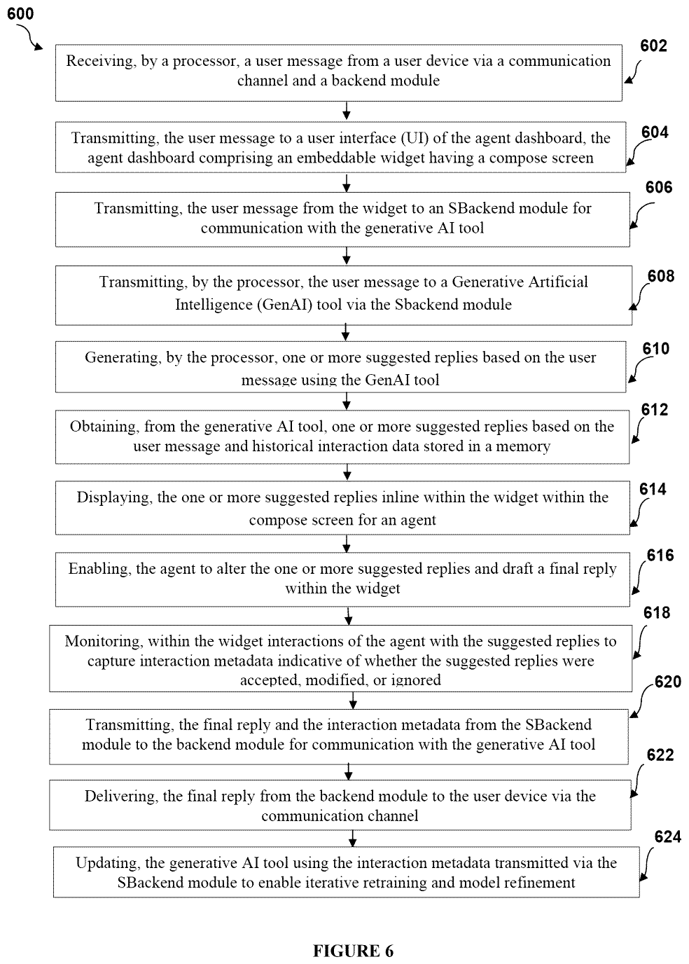

In an embodiment, the FIG. 6 illustrates a flow chart performing a method (600) for integrating Generative AI tool (110) with intelligent agent dashboard using a system (100) comprising a processor (107) coupled with a memory (105), in accordance with an embodiment of the present subject matter. The order in which the method (600) may be described may be not intended to be construed as a limitation, and any number of the described method blocks may be combined in any order to implement the method (600) or alternate methods. Additionally, individual blocks may be deleted from the method (600) without departing from the spirit and scope of the subject matter described herein. Furthermore, the method (600) may be implemented in any suitable hardware, software, firmware, or combination thereof. However, for ease of explanation, in the embodiments described below, the method (600) may be considered to be implemented as described in the system (100) for Generative AI tool (110) with intelligent agent dashboard.

In an embodiment, the method (600) for integrating a generative AI tool with intelligent agent dashboard, using a system (100) comprising a memory (105) and a processor (107) operably coupled to the memory (105), wherein the memory (105) is configured to store message metadata, target user lists, and message templates.

At step (602), receiving, by a processor (107), a user message from a user device (102) via a backend module (106) and a communication channel (104).

At step (604), transmitting, by the processor (107), the user message to a user interface (UI) of an agent dashboard (108) via the backend module (106), wherein the UI displays of the agent dashboard comprises an embeddable compose screen (114) having a compose screen to display the user message.

At step (606), transmitting, by the processor (107), the user message from the widget (114) to an SBackend module (112) for communication with the generative AI tool (110)).

At step (608), transmitting, by the processor (107), the user message to a Generative Artificial Intelligence (GenAI) tool (110) via the Sbackend module (112).

At step (610), generating, by the processor (107), one or more suggested replies based on the user message using the GenAI tool (110), wherein the GenAI tool (110) is trained using the user message and historical data.

At step (612), obtaining, from the generative AI tool (110), one or more suggested replies based on the user message and historical interaction data stored in a memory (105). Further, receiving, by the processor (107), the one or more suggested replies from the GenAI tool via the Sbackend module (112).

At step (614), displaying, by the processor (107), the one or more suggested replies inline within the widget (114) within the compose screen for an agent (116).

At step (616), the agent (116) to alter the one or more suggested replies and draft a final reply within the widget (114).

At step (618), e within the widget (114), interactions of the agent (116) with the suggested replies to capture interaction metadata indicative of whether the suggested replies were accepted, modified, or ignored.

At step (620), the final reply and the interaction metadata from the SBackend module (112) to the backend module (106) for communication with the generative AI tool (110). The matadata indicates the agent interaction with the one or more suggested replies of the GenAI tool (110).

At step (622), delivering, the final reply from the backend module (106) to the user device (102) via the communication channel (104).

At step (624), updating, the generative AI tool (110) using the interaction metadata transmitted via the SBackend module (112) to enable iterative retraining and model refinement.

Some embodiments of the present subject matter enable to integration of a compose widget in any agent dashboard as an externally linkable widget.

Some embodiments of the present subject matter enable to integration of the generative AI dashboard with GenAI integration via the proposed system.

Some embodiments of the present subject matter enable to provide human agents to receive suggestions from GenAI regarding how to respond to end-user queries.

Some embodiments of the present subject matter enable to reduction of human agent effort and the cost of integration.

Some embodiments of the present subject matter enable to eliminate the need for a complete system overhaul and reduce development time.

Some embodiments of the present subject matter enable to provide contextually relevant AI-generated suggestions.

Some embodiments of the present subject matter enable to provide feedback loop mechanism for training the GenAI tool

Some embodiments of the present subject matter enable to reduce latency and improve efficiency.

Some embodiments of the present subject matter enable to ensure uninterrupted agent workflows using the embedded widget.

Some embodiments of the present subject matter enable to enhance agent productivity and reduces decision fatigue for support agents.

Some embodiments of the present subject matter enable to support diverse user devices and compatible with various messaging channels.

Some embodiments of the present subject matter enable to facilitate language translation.

Some embodiments of the present subject matter enable to facilitate voice integration.

Some embodiments of the present subject matter enable to provide a system capable to update, scale, or replace independently the modules.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to.” the term “having” should be interpreted as “having at least.” the term “includes” should be interpreted as “includes but is not limited to.” etc.).

1. A system (100) for integrating a generative AI tool with an agent dashboard, the system (100) comprising:
a memory (105) configured to store information, comprising message metadata, target user lists, and message templates; and
a processor (107) operably coupled to the memory (105), wherein the processor (107) is configured to perform the following steps:
receive (602) a user message from a user device (102) via a communication channel (104) and a backend module (106);
transmit (604) the user message to a user interface (UI) of an agent dashboard (108), the agent dashboard comprising an embeddable widget (114) having a compose screen,
transmit (606), the user message from the widget to a Sbackend module (112) for communication with a generative AI tool (110);
obtain from the generative AI tool (110), one or more suggested replies based on the user message and historical interaction data stored in the memory (105);
display (614) the one or more suggested replies inline within the widget (114) within the embeddable compose screen (114) for an agent (116);
enable (616) altering of the one or more suggested replies within the widget and draft a final reply within the widget (114);
monitor within the widget (114), agent interactions with the suggested replies to capture interaction metadata indicative of whether the suggested replies were accepted, modified, or ignored;
transmit (618) the final reply and interaction metadata from the SBackend module (112) to the backend module (106) for communication with the generative AI tool (110);
deliver the final reply from the backend module (106) to the user device (102) via the communication channel (104); and
update the generative AI tool (110) using the interaction metadata transmitted via the SBackend module (112) to enable iterative retraining and model refinement.

2. The system (100) of claim 1, wherein capturing the interaction metadata within the widget (114) comprises:
detecting a selection event when the human agent (116) chooses one of the suggested replies without modification;
detecting an editing event when the human agent (116) modifies the suggested reply before transmission as the final reply; and
detecting an ignore event when the human agent (116) drafts the final reply independently of the suggested replies,
wherein the widget (114) generates metadata corresponding to the detected events and forwards the metadata to the SBackend module (112).

3. The system (100) as claim in claim 1, wherein the UI (108) displays the user message to the agent (116) with an embeddable compose screen (114), and wherein each agent (116) from a plurality of agents access the UI (108) for interaction with a user from a plurality of users.

4. The system (100) as claim in claim 1, wherein the GenAI tool (110) is configured to generate one or more suggested replies to the received user message comprises a large language model (LLM) trained on historical data and the user messages, and wherein the historical data comprises domain-specific knowledge, customer support datasets, and historical interaction data.

5. The system (100) as claim in claim 1, wherein the widget (114) is operably connected to the processor (107) through the SBackend module (112), such that all communication between the widget (114) and the generative AI tool (110) is routed via the SBackend module (112); and wherein the widget (114) generates the interaction metadata by logging click events, keystroke activity, or input differentials corresponding to the agent's interaction.

6. The system (100) as claim in claim 1, wherein the metadata comprises user identifiers, user messages, agent replies, GenAI-generated replies, agent-edited replies, advertisement identifiers, referral codes, attributes required to uniquely identify and track messages, GenAI-generated suggestions, the selected or edited version, agent interactions, timestamps, campaign identifiers, use-case category, and tags indicating the agent's interaction behavior.

7. The system (100) as claim in claim 1, wherein the embeddable compose screen (114) is implemented as a reusable web component comprising a text input box for composing replies, a section for rendering GenAI-suggested replies, and scripting logic for sending and receiving messages to and from the GenAI backend.

8. The system (100) as claim in claim 1, wherein the embeddable compose screen (114) is integrated into the agent dashboard by replacing a pre-existing compose text box with a custom web component.

9. The system (100) as claim in claim 1, wherein the UI (108) of the agent dashboard further comprises a multilingual preview display, a scorecard for AI reply quality, a tone or style recommender, conversation history, user information, interaction metadata, report, and contextual metadata display.

10. A method (600) for integrating a generative AI tool with intelligent agent dashboard, using a system (100) comprising a memory (105) and a processor (107) operably coupled to the memory (105), wherein the memory (105) is configured to store message metadata, target user lists, and message templates, the method (600) comprising:
receiving (602), by a processor (107), a user message from a user device (102) via a communication channel (104) and a backend module (106);
transmitting (604), the user message to a user interface (UI) of the agent dashboard (108), the agent dashboard comprising an embeddable widget (114) having a compose screen;
transmitting (606), the user message from the widget (114) to an SBackend module (112) for communication with the generative AI tool (110);
obtaining (612), from the generative AI tool (110), one or more suggested replies based on the user message and historical interaction data stored in a memory (105);
displaying (614), the one or more suggested replies inline within the widget (114) within the compose screen for an agent (116);
enabling (616), the agent (116) to alter the one or more suggested replies and draft a final reply within the widget (114);
monitoring (618), within the widget (114), interactions of the agent (116) with the suggested replies to capture interaction metadata indicative of whether the suggested replies were accepted, modified, or ignored;
transmitting (620), the final reply and the interaction metadata from the SBackend module (112) to the backend module (106) for communication with the generative AI tool (110);
delivering (622), the final reply from the backend module (106) to the user device (102) via the communication channel (104); and
updating (624), the generative AI tool (110) using the interaction metadata transmitted via the SBackend module (112) to enable iterative retraining and model refinement.
